(19) United States
(12) Patent Application Publication
(10) Pub. No.: US 2022/0038892 A1
(43) Pub. Date: Feb. 3, 2022

(54) Mathematical Summaries of Telecommunications Data for Data Analytics

(71) Applicant: Eureka Analytics Pte Ltd, Singapore (SG)

(72) Inventors: Ying Li, Singapore (SG); Aloysius Lim, Singapore (SG)

(73) Assignee: Eureka Analytics Pte Ltd, Singapore (SG)

(21) Appl. No.: 17/275,723

(22) PCT Filed: Oct. 26, 2018
(86) PCT No.: PCT/SG2018/050542

§ 371 Date: Mar. 12, 2021

(51) Int. Cl. H04W 12/02; H04W 8/20; G06F 16/2458; G06F 16/22; G06F 21/62

(52) U.S. Cl. CPC H04W 12/02; H04W 8/20; G06F 21/6254; G06F 16/22; G06F 16/2462

(57) ABSTRACT

Telecommunications data may be summarized into mathematical statistics that may not correlate with conventional semantic attributes. Such statistics may be difficult to observe without access to the telecommunications data, and therefore may be much less susceptible to social engineering attacks or other privacy-related vulnerabilities. The mathematical statistics may represent first, second, or higher order behavior-related observations relating to subscribers physical movements, engagement of applications and web browsing on a mobile device, as well as usage and billing of a mobile device. The statistics may not correlate to semantic identifiers for subscribers, and therefore may be difficult to observe and therefore identify specific subscribers whose statistical summaries may be known.

### CROSS REFERENCE TO RELATED APPLICATIONS

This application claims priority to and benefit of PCT/SG2018/050542 “Mathematical Summaries of Telecommunications Data for Data Analytics” filed 26 Oct. 2018 by Eureka Analytics Pte Ltd., the entire contents of which are hereby incorporated by reference for all it discloses and teaches.

### BACKGROUND

Telecommunications network providers have interesting insights into their subscriber's behaviors. For example, telecommunications network providers may have knowledge of a subscriber's movements based on their communications with cell towers as well as knowledge of a user's web browsing behavior from the Uniform Resource Identifiers (URIs) of web sites that a user may browse.

Telecommunications network providers often have restrictions on the uses of the data because of privacy considerations. In some jurisdictions, only specific types of data may be collected and used, while other types of data may only be accessed with a court order.

### SUMMARY

Telecommunications data may be summarized into mathematically defined statistics that may or may not correlate with conventional semantic features. Such statistics may be difficult to observe without access to the telecommunications data itself, and therefore may be much less susceptible to social engineering attacks or other privacy-related vulnerabilities. The mathematical statistics may represent first, second, or higher order behavior-related observations relating to subscribers physical movements, engagement of applications and web browsing on a mobile device, as well as usage and billing of a mobile device. The statistics may not correlate to semantic identifiers for subscribers, and therefore may be difficult to observe and therefore identify specific subscribers whose statistical summaries may be known.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a telecommunications network and creating mathematically descriptive statistics from the data.

FIG. 2 is a diagram illustration of an embodiment showing a network environment for generating mathematically descriptive statistics from telecommunications data.

FIG. 3 is a flowchart illustration of a first embodiment showing a method for processing raw telecommunications data.

FIG. 4 is a diagram illustration of a second embodiment showing a method for processing raw telecommunications data.

FIG. 5 is a flowchart illustration of an embodiment showing a method for processing queries from applications.

FIG. 6 is a flowchart illustration of an embodiment showing a method for operating an application with some steps performed by a telecommunications network.

### DETAILED DESCRIPTION

Mathematical Summaries of Telecommunications Data for Data Analytics

Telecommunications networks may have access to subscriber usage behavior that may be used for various applications, such as targeted advertising, credit score analysis, classification, and other functions. These behavior characteristics may help identify subscribers that share common traits, which may be useful in different business contexts.

One of the benefits, and one of the complexities of telecommunications data is that extremely large amounts of data may exist. For example, each typical cellular phone may perform handshaking with a cell tower on a very high frequency, which may be on the order of every minute or less. Minute by minute observations of every subscriber for millions of subscribers result in data sets that may be extremely large and cumbersome, yet may be very detailed and rich with potential meaning.

Mathematical summaries of telecommunications data may include statistics that may capture subscriber behavior in manners that may be difficult to observe otherwise. Such statistics may be either impossible to observe in the physical world or may not correlate to observations in the non-telecommunications world, and therefore social engineering attacks or other privacy issues relating to such statistics may be lessened.

Privacy vulnerabilities including social engineering attacks may use so-called “open source intelligence,” which may be information about a person that may be publicly available or publicly observable. Publically available information may be, for example, property ownership records that may identify the owner of a home. Publicly observable data may be the observation of a subscriber as the subscriber waits at a public bus stop. Additionally, some observations about a person may not be publicly observable but may be observable by a third party, such as information regarding a retail transaction made by a subscriber at a local store.

Such non-telecommunications-related intelligence about individual subscribers may be difficult if not impossible to correlate with mathematical summaries of telecommunications data. Because correlation may be very difficult, the presence of such mathematical summaries may not pose a privacy vulnerabilities. Some analysts may consider such mathematical summaries “inherently” private because of the lack of correlation with directly observable characteristics.

The privacy characteristics of mathematical summaries may dramatically reduce the legal exposure of companies handling such summaries. Many jurisdictions have laws that restrict the transfer of personally identifiable information, and by handling only mathematical summaries of telecommunications data, useful data may be shared without compromising privacy laws or without identifying individual subscribers.

In many cases, summary statistics gathered from telecommunications data may not correlate with directly observable physical activities because of inherent inaccuracies in the telecommunications data. For example, consider a statistic of a radius of gyration, which may represent a subscriber's radius of movement over a period of time, such as a day, week, work week, weekend, month, or some other time period. Even when a subscriber's radius of gyration may be calculated with the highest level of precision of latitude and longitude available from the telecommunications network, such latitude and longitude numbers may be that of the cell towers to which a subscriber's device may communicate. Such cell towers may be miles or kilometers away from the actual location of the subscriber. Consequently, a physical observation of a subscriber's daily activities could be used to calculate a radius of gyration, but such a radius of gyration may not exactly match a radius of gyration calculated using telecommunications network data.

The net result may be that if a subscriber's mathematical summary of a radius of gyration were publically available, there may be no way to physically observe that the specific radius of gyration correlated to that specific subscriber. In such a situation, the radius of gyration may be an inherently private statistic for which no separate set of physical observations can correlate to the statistic generated from telecommunications data.

Such mathematical summaries may be considered to be second, third, or higher order representations of subscriber behavior. A first order observation of a subscriber behavior may be a subscriber's presence at a physical location and at a specific time. A second order statistic may be a journey along a street or bus line. A third order or higher order statistic may gather all journeys into a single representation, such as a radius of gyration. A higher order statistic may analyze the changes in radius of gyration over time, such as to determine that a subscriber may have taken journeys outside of the subscriber's normal movement patterns.

Such high order statistics may not compromise a subscriber's identity but may capture information that may be useful for many applications, such as for advertising, transportation or movement pattern analysis, credit scoring, or countless other uses for the data.

Many mathematical statistics may not correlate with conventional semantic descriptors of a subscriber. Semantic descriptors, for the purposes of this specification and claims, may be any descriptor that may be observed from non-telecommunications data. Examples of semantic descriptors may be gender, age, race, job description, income, and the like.

In some cases, some semantic descriptors may be estimated or implied from telecommunications data. For example, a subscriber's family size may be implied based on the SMS text and calling patterns of the subscriber, as well as analysis of the movement of those people with whom the subscriber frequently communicates. The communication patterns may identify people with whom the subscriber has an ongoing relationship, and the movement patterns may identify those people who may be in the same location as the subscriber at various times of day, such as in the evening when the subscriber's family may gather at home.

Mathematical descriptors that may be semantic-free may be those descriptors that do not correlate with characteristics that may be readily observable outside of the telecommunications network data. Such statistics may refer to a subscriber's interactions with the telecommunications network, their physical movement patterns as derived from telecommunications network observations, and other characteristics.

Some telecommunications network observations may be inherently non-observable from outside the telecommunications network. For example, a subscriber's usage of SMS text and voice calls may not be observable without access to the telecommunications network logging and observation infrastructure. In many jurisdictions, the contents of a subscriber's communications may be private and unavailable without a court order, but the metadata relating to such communications may or may not be accessible. Such metadata may indicate the phone number called by a subscriber, whether the call or text was inbound or outbound, the length of the call or text, and other observations.

Another example of inherently non-observable telecommunications data may relate to a subscriber's physical movements. Many movements of mobile devices may be observed by a telecommunications network with poor accuracy. For example, many location observations may be given as merely the location of a cell tower to which a subscriber may be connected, or a relatively coarse estimation of location by triangulating a location between two, three, or more cell towers. When a cell tower location may be given as a subscriber's location estimation, the cell tower may be several kilometers or miles away from the actual subscriber. Similarly, triangulated locations may be accurate to plus or minus several tens or hundreds of meters.

In some cases, a subscriber's device may generate Global Positioning System or other satellite-based location data. In many cases, such satellite location data may be much more accurate than location observations gathered from cellular towers. However, such satellite location data may typically consume battery energy from a subscriber device and may not be used at all times. In some cases, highly accurate data, such as satellite location data, may be obscured, desensitized, salted, or otherwise obfuscated prior to generating statistics such that the telecommunications observations may not directly correlate with physical observations.

Such inherent inaccuracy may be sufficient for the telecommunications network to manage network loads, yet may be so inaccurate that a physical observation of a subscriber at a specific location may not directly correlate with the telecommunications network's observation of that subscriber. In this manner, telecommunications network observations may be inherently unobservable in the physical world and therefore statistics generated from such observations may inherently shield a subscriber from being identified from the statistics.

Higher order statistics may have more inherently private characteristics since identifying a specific subscriber may be increasingly more difficult. For example, the number of text messages sent in an hour may be considered a first order statistic, which may be nearly impossible to observe without access to telecommunications network data. However, the mean number of text messages per hour made by the subscriber over a day may be much more difficult to observe. The mean, in this case, may be considered a second order statistic, as the mean can be considered to encapsulate multiple first order statistics. The covariance of a subscriber's text messages per hour over the course of a week may be a third order statistic, and would be increasingly difficult to observer without direct access to telecommunications network data. A higher order statistic may be an entropy analysis of a subscriber's text behavior over a period of time, for example.

Such higher order statistics may capture valuable and useful behavior characteristics of subscribers without giving away the identity of a specific subscriber, even if the statistics were publicly accessible.

Database records with first order or higher statistics may be very difficult or impossible to identify a specific subscriber from the statistics. Using the example of the statistics above, a database record with a subscriber's number of text messages per hour, the mean text messages sent per hour, the covariance of text messages per hour, and the entropy of text behavior would not enable an outside observer to identify which subscriber has those characteristics, unless the observer had direct access to the underlying telecommunications data.

Such may not be the case when semantic meaning may be interpreted from telecommunications data. Semantic meaning may include demographic information, such as gender, age, income level, family size, and other information. Such semantic identifiers may be readily observable in the real world and may compromise the privacy of a database of mathematically descriptive statistics.

In many cases, databases of mathematical statistics of telecommunications network data may include anonymized identifiers for subscribers. For example, a database of statistics may include a hashed or otherwise anonymized identifier for a subscriber's telephone number or other identifier, along with the statistics derived from the subscriber's observations. Some systems may maintain a database table that may correlate the subscriber's actual identifier, such as a telephone number, with the hashed or anonymized identifier. Such a table may be protected using the same techniques and standards as private subscriber data, but a database with hashed or anonymized identifiers along with semantic-free, mathematically descriptive statistics may be shared without jeopardizing subscriber privacy.

One factor that may affect the privacy of subscribers may be the scarcity of data. In an extreme example, a telecommunications network with a single subscriber may generate statistics that may inherently identify the only subscriber. However, with thousands or even millions of subscribers, a single set of observations may not allow a party without access to personally identifiable information to identify a subscriber.

Some systems may analyze queries to ensure that at least a predefined number of results may be returned from a query. When a query returns less than the predefined number of results, the query may be performed with obfuscated or otherwise less accurate data. For example, a query that may return location-based observations may be re-run with desensitized location data such that a larger number of results may fulfil the query. Some systems may return salted, fictitious, or modified results in addition to the true results such that an analyst may not be able to identify a valid result.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

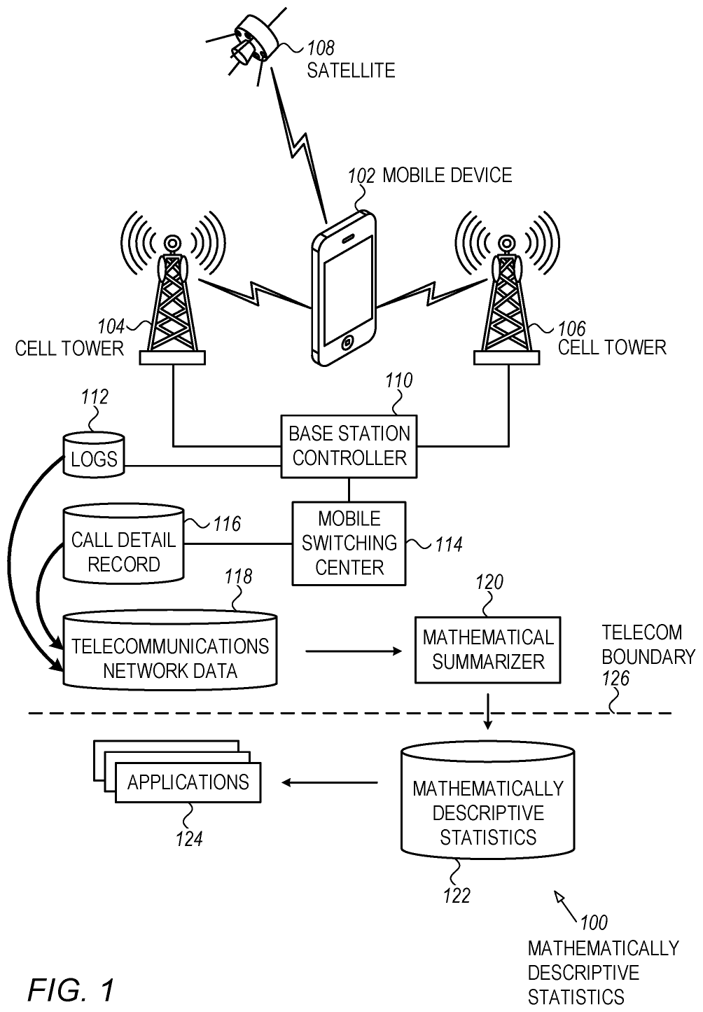

FIG. 1 is a diagram illustration of an embodiment 100 showing a system for creating and using mathematically descriptive statistics. The mathematically descriptive statistics may be generated from telecommunications network data and may be semantic-free, such that the statistics themselves may be difficult or impossible to observe without direct access to the underlying raw telecommunications data.

A mobile device 102 may communicate with various cell towers 104 and 106. The communications may include text or short message system (SMS) messages, voice calls, data communications, but may also include handshaking, handoffs, status messages, and other administrative or network management communications. The cell towers 104 and 106 may be managed by a base station controller 110, which may manage the communications between mobile devices and the telecommunications network. The base station controller 110 may generate various logs 112, which may capture some or all of the interactions with the mobile device 102. In many cases, the logs 112 may include a timestamp, an identifier for the mobile device 102, and implied or explicit location information about the mobile device 102.

The mobile device 102 may have a satellite location receiver, which may receive signals from various satellites 108. The signals from the satellites 108 may be used to determine a location for the mobile device 102 with various levels of accuracy. In many cases, a telecommunications network may be able to capture satellite location information that may be gathered by a mobile device 102. Such location information may be stored in one of various logs and may store the location of a mobile device with greater accuracy than a location derived from a base station log.

Various base station controllers 110 may be connected to a mobile switching center 114. A mobile switching center 114 may connect to many base station controllers and may manage calls and other communication going into and out of the telecommunications network. Many of such calls may occur between subscribers of the network, but many more may occur outside of the network, including calls to a Packet Switched Telephone Network (PSTN), to other telecommunications network, to the Internet, or other communications pathways. The mobile switching center 114 may create call detail records 116, which may capture logging and billing information for each subscriber on the network.

The call detail records 116 may include a timestamp and information about a call, text, or data communication. Call information, for example, may include the origin or destination number and duration. Text information may include the origin or destination number and size of data payload. Data communication information may include the origin or destination of the data, plus the size and duration of the communication.

The logs 112 and call detail records 116 may be considered telecommunications network data 118. The telecommunications network data 118 may include information gathered for billing purposes, which may be represented by the call detail records 118. The telecommunications network data 118 may also include operational information collected for managing the network. Such an example may include the logs 112 gathered from communications made between cell towers and various mobile devices. Such information may be used to manage the connectivity of devices, adjust network loading at different towers, perform handoffs between towers, and other network operations. Such information may be internal to the telecommunications network and may not generally be available outside of the operations of a network.

A mathematical summarizer 120 may be a process by which the telecommunications network data 118 may be converted into mathematically descriptive statistics 122, which may be semantic-free and may be anonymized such that subscribers may be identified with a hashed or otherwise obfuscated identifiers. The mathematically descriptive statistics 122 may be used by various applications 124 to query against. The applications may include statistical analysis of subscriber behavior, lookalike analysis, credit scoring, and many other uses.

The mathematically descriptive statistics 122 may be located outside of the telecommunications network boundary 126. In many cases, telecommunications network data 118 may include private information, such as subscriber usage metadata, subscriber locations, and other information which may be protected by law or regulation in different jurisdictions. When such information has been summarized into mathematically descriptive statistics which may be semantic-free, such information may be difficult to identify specific subscribers from the data. Therefore, such information may be handled outside of the telecommunications network boundary 126 with fewer privacy issues than with the raw underlying data.

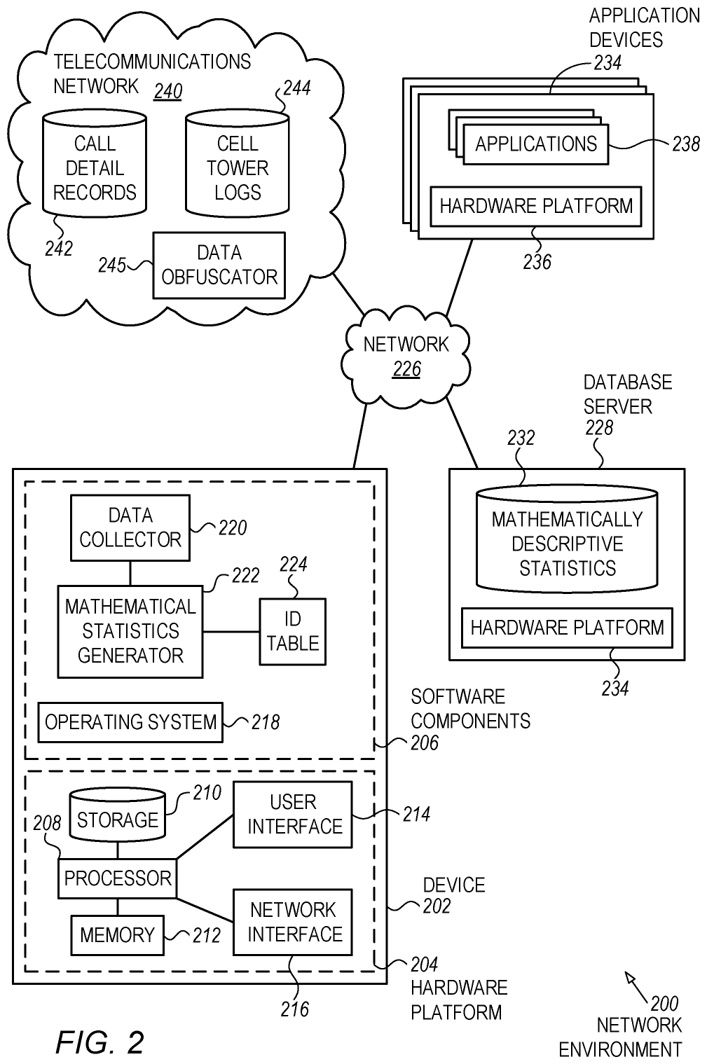

FIG. 2 is a diagram of an embodiment 200 showing components that may create mathematically descriptive statistics that may be used for various applications. The statistics may summarize various telecommunications network data into a form that may be semantic-free yet useful for various analyses. Such data may be inherently private, in that specific subscribers may not be identifiable from the data, except when there may be direct access to the raw underlying data.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A data collector 220 may retrieve raw telecommunications data periodically and prepare data to be summarized by a mathematical statistics generator 222. Many statistics may involve time series data, which may measure changes to various factors over time. Such time series data may be updated periodically to identify changes in subscriber behavior, and the data collector 220 may manage the timing and update of those statistics.

The mathematical statistics generator 222 may process raw telecommunications data to create mathematical representations of the data which may reflect behavioral differences between subscribers. The behavioral differences may be reflected in various statistics, allowing for various applications to identify subscribers that behave in similar or dissimilar fashions.

The raw data may include call data record data, which may include a timestamp, an event designator such as voice call, data transmission, or SMS communication, a sender identifier, a sender telephone number, a receiver identifier, a receiver telephone number, a call duration, data upload volume, and data download volume. An internet communication record may include a timestamp, a subscriber identifier, a subscriber telephone number, and a domain name. The domain name may be extracted from a Uniform Resource Identifier (URI) that may be retrieved from the Internet in response to an application or browser access of Internet data.

A location record may include a timestamp, a subscriber identifier, and latitude and longitude. Some telecommunications data may include customer relationship management records, which may include a month, a subscriber identifier, an activation date, a prepaid or postpaid plan identifier, a late payment indicator, an average revenue per unit, and a prepaid top-up amount.

The raw telecommunications data may be aggregated for each subscriber, then statistics may be generated from the aggregated data. In many cases, a large number of statistics may be used by various unsupervised learning mechanisms, then the unsupervised learning systems may determine which statistics may have the highest influence. Such systems may benefit from very large numbers of statistics from which to select meaningful statistics, and in many cases, some use cases may identify one set of statistics that may be significant, while another use case may find that a different set of statistics may be significant. Such systems may benefit from a large set of different statistics.

In some systems, raw telecommunications data may be obfuscated prior to analysis. Obfuscation may limit the precision, accuracy, or reliability of the raw data, but may retain sufficient statistical significance from which similarities and other analyses may be made. One mechanism for obfuscating data may be to decrease the precision of the data. For example, many raw telecommunications data entries may include a timestamp, which may be provided in year, month, day, hours, minutes, and seconds. One mechanism to obfuscate the data may be to remove the seconds or even minutes data from the timestamps, or to put the time stamps into buckets, such as buckets for every 15 or 20 minutes within an hour. Such a reduction in granularity may preserve some meaning of many of the statistics while obscuring the underlying data.

Another application of data obfuscation may be to limit the precision of location information. For example, some location information may have a high degree of precision, such as Global Positioning System (GPS) satellite location data. A method of obfuscation may be to limit the latitude and longitude to only one or two digits past the decimal point for such data points. Such an obfuscation may limit the location precision to approximately 1 km or 100 m, respectively.

Another obfuscation method may be applied to web browsing history, which may be obfuscated by limiting any Uniform Resource Identifier (URI) data entries to the top level domain only. Many URI records may include several parameters that may identify specific web pages or may embed data into a URI. By removing such excess information, web page or application access to the Internet may be obfuscated.

Statistics that may be generated from the telecommunications data may include first, second, and third order statistics such as count, sum, maximum, minimum, mean, frequency, ratio, fraction, standard deviation, variance, and other statistics. Such statistics may be generated from any of the various

Higher order statistics may include entropy. Entropy may be the negative logarithm of the probability mass function for a value, and may represent the disorder or uncertainty of the data set. Entropy may further be analyzed over time, where changes in entropy may identify behavioral changes by a subscriber. For example, in telecommunications data, a cell tower log may identify that a subscriber's device was in the vicinity of the cell tower. In this case, the cell tower locations may be a proxy for a subscriber's location, and the entropy of the subscriber's interactions with the location may reflect the subscriber's movement behavior.

Other higher order statistics may include periodicity, regularity, and inter-event time analyses. Periodicity analysis may identify a subscriber's regular behaviors, which may be caused by sleep patterns, job attendance, recreation, and other activities. Even though the specific activities of the subscriber may not be directly identified by the telecommunications data, the effects of those behaviors may be present in the mathematically descriptive statistics. Periodicity may be identified through Fourier transformation analysis or auto-correlation of time series of the subscriber's behaviors. Such analyses may be performed against location-related information, but also other data sets, such as texting, calling, and web browsing activities. Regularity may be statistics related to the consistency of the behaviors, while the inter-event time analyses may generate statistics relating to the time between events or sequence of events.

Some statistics may be generated from interactions between subscribers. Many subscribers may have a small number of other people with whom the subscriber may communicate frequently. Such people may be family members, friends, coworkers, or other close associates. The interactions may be consolidated into a graph of subscribers. In some cases, a pseudo social network graph may be created by identifying subscribers with common attributes, such as subscribers who may visit a specific cell tower location. From such graphs, several types of centrality and other attributes may be calculated. Centrality may be in the form of degree centrality, closeness centrality, betweenness centrality, eigenvector centrality, information centrality, and other statistics. Other attributes may include nodal efficiency, global and local transitivity, relationship strengths, and other attributes.

The statistics may be categorized by communication features, location features, online features, and social network features. Each feature may be a statistic calculated from the raw telecommunications data and may be inherently unobservable from outside the telecommunications network. Further, such features may be a first order or higher statistic that may not correlate with or contain semantic information about a subscriber.

TABLE 1
List of Communication Features

| | | | Derived | |
|---|---|---|---|---|
| Statistic | Type | Units | from | Direction |
| Count of communica- | Integer | Communica- | Call, | In, Out, |
| tions | | tions | SMS, | Both |
| | | | both | |
| Proportion of SMS to | Percentage | Unitless | Both | In, Out, |
| call + SMS | | | | Both |
| Proportion of outgoing | Percentage | Unitless | Call, | Both |
| to incoming + outgoing | | | SMS, | |
| communications | | | Both | |
| Sum of call duration | Integer | Seconds | Call | In, Out, |
| | | | | Both |
| Mean call duration | Decimal | Seconds | Call | In, Out, |
| | | | | Both |
| S.D. of call duration | Decimal | Seconds | Call | In, Out, |
| | | | | Both |
| Mean interevent time | Decimal | Seconds | Call, | In, Out, |
| | | | SMS, | Both |
| | | | Both | |
| S.D. of interevent | Decimal | Seconds | Call, | In, Out, |
| time | | | SMS, | Both |
| | | | Both | |
| Count of responses | Integer | Communic | [symbol] , | Out |
| | | | SMS, | |
| | | | Both | |
| Fraction of | Ratio | Unitless | Call, | Out |
| communications | | | SMS, | |
| responded | | | Both | |
| Mean response time | Decimal | Seconds | Call, | In, Out, |
| | | | SMS, | Both |
| | | | Both | |
| S.D. of response time | Decimal | Seconds | Call, | In, Out, |
| | | | SMS, | Both |
| | | | Both | |
| Communications | Decimal | | Call, | In, Out, |
| regularity | | | SMS, | Both |
| | | | Both | |
| Autoregression | Decimal | | Call, | In, Out, |
| coefficient | | | SMS, | Both |
| | | | Both | |

[symbol]

indicates data missing or illegible when filed

TABLE 2
List of Location Features

| Feature | Type | Unit | Time Dimension |
|---|---|---|---|
| Count of total locations | | | |
| interacted with | | | |
| Count of distinct locations | | | |
| interacted with | | | |
| Count of hand-off's (if | | | |
| there is any) | | | |
| top 5 locations interacted | | | |
| with | | | |
| total distance traveled | | | |
| Mean (over days) radius of | Decimal | Kilometres | W × (T ∪ D) |
| gyration | | | |
| Sum of distance travelled | Decimal | Kilometres | W × (T ∪ D) |
| Count of locations visited | Integer | Locations | W × (T ∪ D) |
| Location entropy | Decimal | Unitless | W × (T ∪ D) |
| Count of frequent locations | Integer | Locations | Month |
| Frequent location entropy | Decimal | Unitless | Month |
| Mean regularity of | Integer | Unitless | Month |
| frequent locations | | | |
| Mean distance from call | Decimal | Kilometres | W × (T ∪ D) |
| counterparty | | | |
| Mean distance from SMS | Decimal | Kilometres | W × (T ∪ D) |
| counterparty | | | |
| Mean distance from | Decimal | Kilometres | W × (T ∪ D) |
| call + SMS counterparty | | | |
| S.D. of distance from call | Decimal | Kilometres | W × (T ∪ D) |
| counterparty | | | |
| S.D. of distance from SMS | Decimal | Kilometres | W × (T ∪ D) |
| counterparty | | | |
| S.D. of distance from | Decimal | Kilometres | W × (T ∪ D) |
| call + SMS counterparty | | | |

TABLE 3
List of Web Usage Statistics

| Feature | Type | Unit | Time Dimension |
|---|---|---|---|
| Count of total web visit | | | |
| Count of distinct domains | Integer | | |
| visited | | | |
| Count of total app use | Integer | | |
| Count of distinct app used | Integer | | |
| top 5 web sites | list | | |
| top 5 app used | Integer | | |
| Diversity of domain | | | |
| Diversity of app use | | | |

TABLE 4
List of Social Network Features

| Dimension | Type | Unit | Mode | Direction |
|---|---|---|---|---|
| Degree centrality | | | Call, SMS, | In, Out, |
| | | | Both | Both |
| Closeness centrality | | | Call, SMS, | Both |
| | | | Both | |
| Betweenness centrality | | | Call, SMS, | Both |
| | | | Both | |
| Eigenvector centrality | | | Call, SMS, | Both |
| | | | Both | |
| Information centrality | | | Call, SMS, | Both |
| | | | Both | |
| Nodal efficiency | | | Call, SMS, | Both |
| | | | Both | |
| Mean nodal efficiency | | | Call, SMS, | Both |
| | | | Both | |
| Local efficiency | | | Call, SMS, | Both |
| | | | Both | |
| Mean local efficiency | | | Call, SMS, | Both |
| | | | Both | |
| Global transitivity | | | Call, SMS, | Both |
| | | | Both | |
| Local transitivity | | | Call, SMS, | Both |
| | | | Both | |
| Mean local transitivity | | | Call, SMS, | Both |
| | | | Both | |
| Davis & Leinhardt's | | | Call, SMS, | Both |
| triads {1, 3, 11, 16} | | | Both | |
| Kalish & Robins' | | | Call, SMS, | Both |
| triads {WWW, SSS, | | | Both | |
| WNW, WSW, SNS, | | | | |
| SNW, SWS, SWW, | | | | |
| SSW} | | | | |
| Mean communications | | | Call, SMS, | In, Out, |
| per contact | | | Both | Both |
| Contacts entropy | | | Call, SMS, | In, Out, |
| | | | Both | Both |
| Subgraph density of | | | Call, SMS, | Both |
| neighbors | | | Both | |
| Count of strong | | | Call, SMS, | Both |
| contacts | | | Both | |
| Mean credit score of | | | | |
| neighbours | | | | |

The mathematical statistics generator 222 may create hashed or otherwise anonymized versions of subscriber's identification. Such information may be placed in an ID table 224 for later correlation in some use cases. In many cases, the mathematically descriptive statistics generated by the mathematical statistics generator 222 may be produced with hashed identifiers such that analyses may not return identifiers that may compromise a subscriber's privacy.

A database server 228 may be connected to the device 202 through a network, and may have a hardware platform 230 on which a database of mathematically descriptive statistics 232 may reside. In many cases, the mathematical statistics generator 222 may operate within a firewall or inside a protected network of a telecommunications network, however, the mathematically descriptive statistics database 232 may reside outside of the protective confines. The separation may allow the mathematically descriptive statistics database 232 to be accessed without the privacy restrictions that may be imposed commercially or through law and regulation for telecommunications network data.

Another architecture may have the mathematical statistics generator 222 operate outside the telecommunications network. Such architectures may operate by first obfuscating the raw telecommunications network data prior to releasing the data for statistical analyses. In such a system, a telecommunications network may remove subscriber identifiers or obscure subscriber identifiers by hashing or other technique. Some such systems may further obscure the underlying data by salting the database with false data, decreasing the precision of time, location, or other parameters, and other techniques. Once obscured, the data may then be passed outside of the telecommunications network for statistical analyses.

A telecommunications network 240 may contain the call detail records 242, cell tower logs 244, and other data sources. In some cases, a data obfuscator 245 may process raw telecommunications data into obscured data for processing outside of the telecommunications network.

Various application devices 234 may have a hardware platform 236 and various application 238 which may access and use the mathematically descriptive statistics database 232. Examples of applications may include lookalike analyses of subscribers for targeted advertising, analyses of movement and traffic patterns of people and vehicles, credit scoring, and countless other applications.

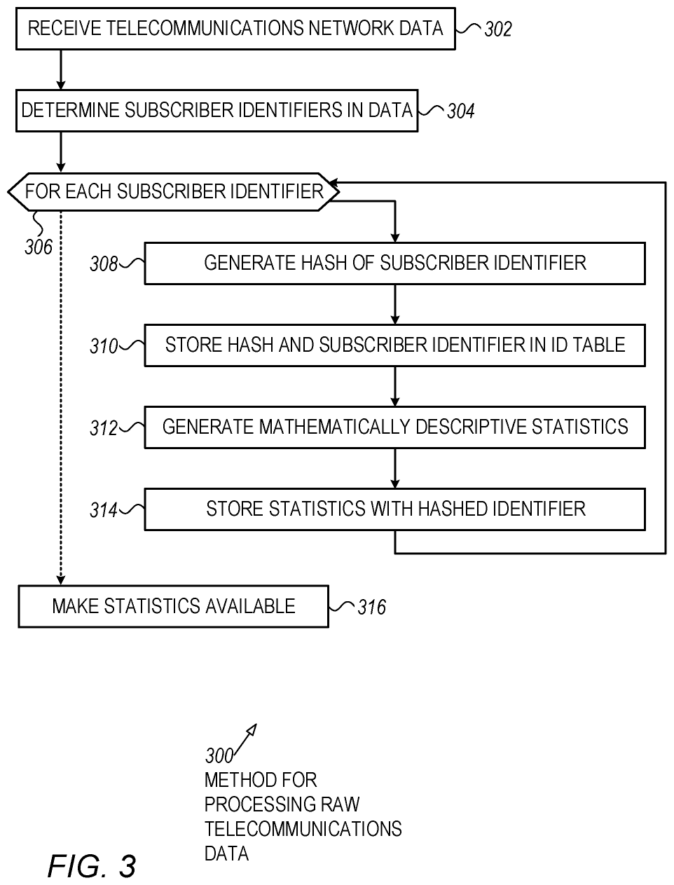

FIG. 3 is a flowchart illustration of an embodiment 300 showing a method of processing raw telecommunications data. Embodiment 300 is a simplified example of a sequence for generating mathematically descriptive statistics, where the statistics may be generated within a telecommunications network.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Telecommunications network data may be received in block 302. Within the network data, the subscriber identifiers may be identified in block 304.

For each subscriber identifier in block 306, a hash of the subscriber identifier may be created in block 308. In some embodiments, some other form of obfuscation may be applied to the subscriber identifier rather than a hash. The hash or other obfuscated subscriber identifier and the original subscriber identifier may be stored in an ID table in block 310.

A suite of mathematically descriptive statistics may be generated in block 312 and stored with the hashed identifier in block 314. After processing the raw data for each individual subscriber identifiers in block 308, the statistics may be made available in block 316.

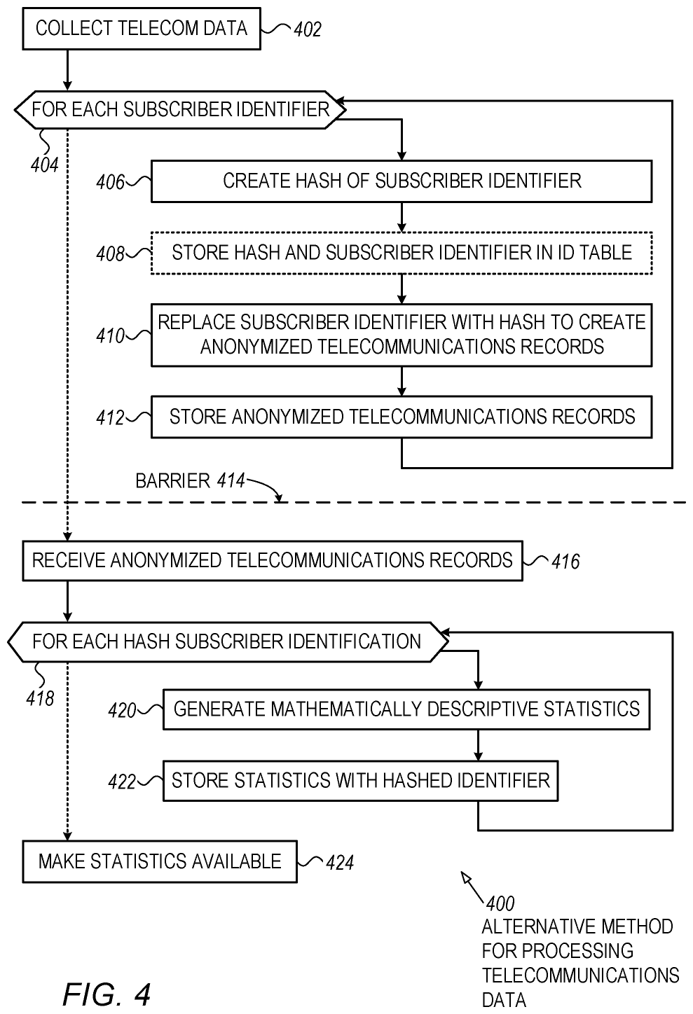

FIG. 4 is a flowchart illustration of an embodiment 400 showing a method of processing raw telecommunications data. Embodiment 400 is a simplified example of a sequence for generating mathematically descriptive statistics, where the statistics may be generated outside a telecommunications network.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 400 may differ from embodiment 300 in that raw telecommunications data may be obfuscated prior to generating mathematically descriptive statistics. In one example of such an embodiment, the subscriber identifiers may be obscured prior to releasing the raw data outside of the telecommunications network boundaries. Such an example may allow the statistics to be generated outside of the telecommunications network boundaries.

The telecommunications network data may be received in block 402. For each subscriber identifier in block 404, a hash of the subscriber identifier may be created in block 406.

The hash and subscriber identifier may be stored in an ID table in block 408. In some cases, the ID table may not be created, and in such cases, the telecommunications network data may be released without having a mechanism to identify subscribers. Some use cases may not use an ID table and, to eliminate the possibilities of privacy breaches, the ID table may not be created.

An example of uses of the telecommunications data where the ID table may not be used may be a study of traffic and people's movements within a geography. The telecommunications network data may be used to identify traffic patterns, change in traffic patterns, and a host of other uses, and the ID table may not be invoked to identify specific subscribers.

On the other hand, some use cases may use an ID table. For example, an analysis may identify subscribers who may be targets for a specific advertisement. Such an analysis may generate a set of hashed subscriber identifiers. The hashed subscriber identifiers may be used with the ID table to identify actual subscriber identifiers, then an advertisement may be sent to those subscribers.

The subscriber identifier may be replaced with the hashed identifier to create an anonymized data set in block 410. The anonymized telecommunications records may be stored in block 412.

The anonymized telecommunications records may be received in block 416. The operations of block 416 and following may be performed outside of the telecommunications network, as illustrated by a barrier 414. The anonymized telecommunications records may be releasable outside of the network because the individual subscriber identifiers may be scrubbed from the dataset.

For each of the hashed subscriber identifiers in block 418, mathematically descriptive statistics may be generated in block 420 and stored with the hashed identifier in block 422. After processing all of the hashed subscriber identifiers in block 418, the statistics may be made available in block 424.

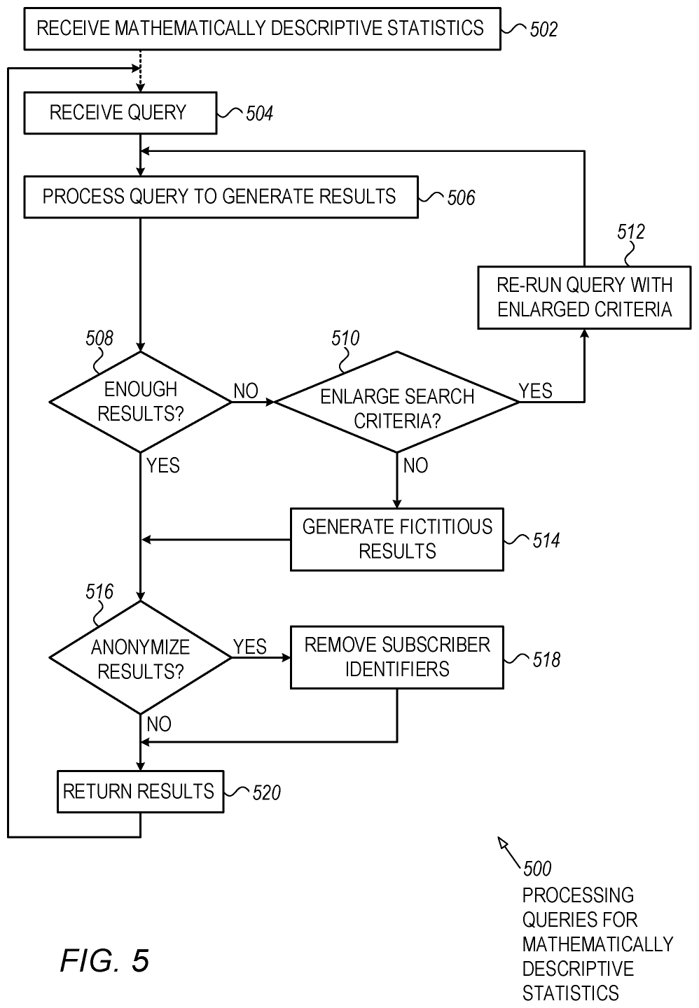

FIG. 5 is a flowchart illustration of an embodiment 500 showing a method of processing queries for mathematically descriptive statistics. Embodiment 500 may illustrate one method for processing a query, then determining that sufficient results exist prior to releasing the results. Such a process may ensure that enough results are present so that privacy may be ensured for subscribers identified in the results.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

The statistics may be received in block 502 into a database. A query may be received in block 504 and may be processed to generate results in block 506.

If enough results were not returned in block 508, the process may proceed to block 510. The number of results may be determined by a predefined minimum number of results. For any set of results that are fewer than the predefined number, the process may proceed to block 510.

In block 510, a decision may be made to expand the search criteria. If the search criteria may be enlarged in block 510, the query may be re-run in block 512 with the enlarged criteria and the process may return to block 506.

If the search criteria may not be enlarged in block 510, fictitious or salted results may be generated in block 514 and added to the results.

In some cases, results may be anonymized in block 516. If the results are to be anonymized in block 516, the subscriber identifiers may be removed in block 518. In many cases, the subscriber identifiers may be a column in a table, where each row may represent the set of statistics for a given subscriber. By removing the column with subscriber identifiers in block 518, the table of results may be anonymized.

The results may be returned in response to the query in block 520.

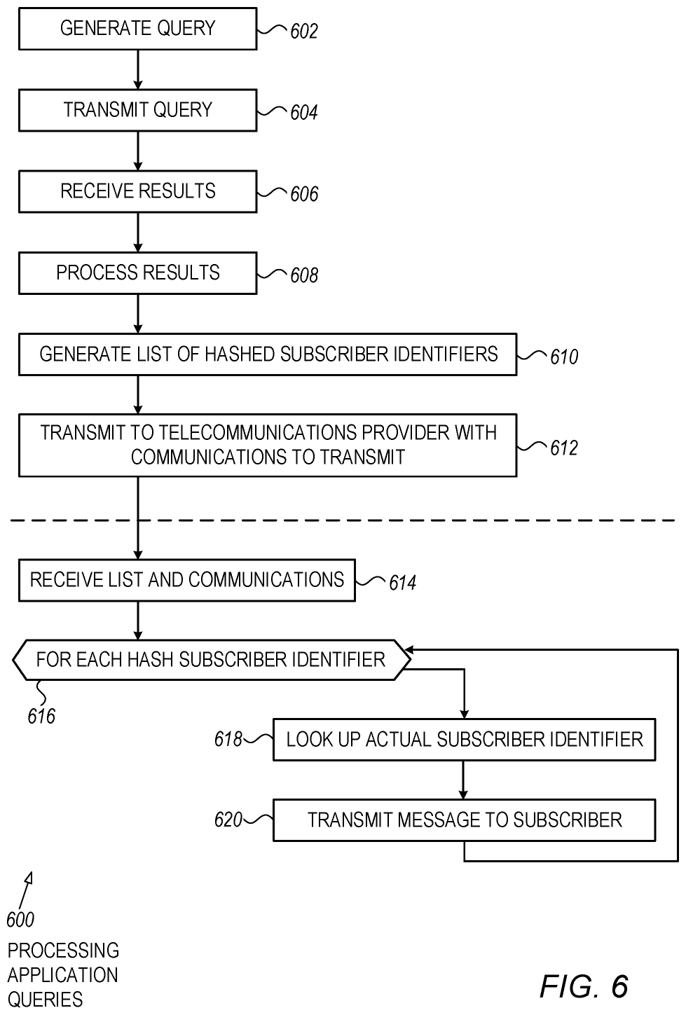

FIG. 6 is a flowchart illustration of an embodiment 600 showing a method of processing application queries. Embodiment 600 is a simplified example of a sequence where an application may generate a query, analyze results, and identify a set of hashed subscriber identifiers for which additional actions may be performed. The list of hashed subscriber identifiers may be transmitted to a telecommunications network for further processing, such as to send advertisements.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

A query may be generated by an application in block 602, transmitted to a database of mathematically descriptive statistics in block 604, results may be received in block 606, and processed in block 608. From processing the results, an application may generate a list of hashed subscriber identifiers in block 610.

In the example of embodiment 600, the hashed subscriber identifiers may be a list of subscribers for which an advertisement may be sent. The list may be transmitted to the telecommunications network in block 612, along with an advertisement or message to send to the identified subscribers.

The telecommunications network may receive the list and the desired communications in block 614. For each of the identified subscribers in block 616, the actual subscriber identifier may be fetched from an ID table in block 618, and the requested message may be sent in block 620.

The example of embodiment 600 may be one example of a system where the telecommunications network may retain an ID table and may have the only access to determine the actual phone number or other identifiers for the hashed identifiers. Such an example may allow a third party application to process the mathematically descriptive statistics without being exposed to data that may be considered private and which may be restricted by law, regulation, or convention.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principals of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
at least one computer processor;
said at least one computer processor configured to perform a method comprising:
receiving telecommunications data comprising cellular tower logs, said cellular tower logs comprising a cell tower identifier, a subscriber identifier, and a timestamp;
for each of said subscriber identifier, generating a set of mathematically descriptive statistics, said set of mathematically descriptive statistics being semantic-free;
storing said mathematically descriptive statistics in a telecom database;
receiving a first query against said telecom database and generating a first subset of said mathematically descriptive statistics; and
returning said first subset of said mathematically descriptive statistics in response to said query.

2. The system of claim 1, said mathematically descriptive statistics being non-zero-order statistics derived from said telecommunications data.

3. The system of claim 2, said mathematically descriptive statistics comprising location-derived statistics.

4. The system of claim 3, said location-derived statistics comprising at least one of a group composed of:
count of total locations;
distance traveled;
radius of gyration; and
location entropy.

5. The system of claim 2, said mathematically descriptive statistics comprising communication-derived statistics.

6. The system of claim 5, said communication-derived statistics comprising at least one of a group composed of:
relationship of text communications with respect to voice communications;
relationship of incoming and outgoing communications;
mean of call duration; and
standard deviation of call duration.

7. The system of claim 2, said method further comprising:
determining that said first subset of said mathematically descriptive statistics is smaller than a predefined number of results;
creating a second subset of said mathematically descriptive statistics comprising said first subset of said mathematically descriptive statistics, said second subset having at least said predefined number of results; and
returning said second subset of said mathematically descriptive statistics.

8. The system of claim 7, said second subset of said mathematically descriptive statistics further comprising fictitious results.

9. The system of claim 7, said second subset of said mathematically descriptive statistics further comprising results from a broader query than said first query.

10. The system of claim 2, said first subset of mathematically descriptive statistics comprising anonymized subscriber identifiers.

11. A system comprising:
at least one computer processor;
said at least one computer processor configured to perform a method comprising:
identifying a first class of activities performed by a mobile device;
identifying a first plurality of activities within said first class of activities;
generating at least one summary statistic for said first plurality of activities, said summary statistic being semantic-free and at least a first order statistic; and
causing said at least one summary statistic to be stored in a database, said at least one summary statistic being associated with an anonymized identification associated with said mobile device.

12. The system of claim 11, said at least one computer processor being located within said mobile device.

13. The system of claim 12, said mobile device having an application operable on said at least one processor, said application being configured to perform said method.

14. The system of claim 12, said mobile device having an operating system-level function operable on said at least one processor, said operating system-level function being configured to perform said method.

15. The system of claim 12, said anonymized identification being determined by a second computer processor.

16. The system of claim 11, said at least one computer processor being location outside said mobile device.

17. The system of claim 16, said method further comprising:
receiving a set of cell tower usage logs and deriving said at least one summary statistic from said set of cell tower usage logs.

18. The system of claim 17, said mathematically descriptive statistics comprising location-derived statistics.

19. The system of claim 18, said location-derived statistics comprising at least one of a group composed of:
count of total locations;
distance traveled;
radius of gyration; and
location entropy.

20. The system of claim 16, said method further comprising:
receiving a set of call detail records and deriving said at least one summary statistic from said set of call detail records.

21. The system of claim 20, said mathematically descriptive statistics comprising communication-derived statistics.

22. The system of claim 21, said communication-derived statistics comprising at least one of a group composed of:
relationship of text communications with respect to voice communications;
relationship of incoming and outgoing communications;
mean of call duration; and
standard deviation of call duration.

23. A system having at least one processor, said system being configured to execute a method on said at least one processor, said method comprising:
receiving telecommunications data comprising cellular tower logs, said cellular tower logs comprising a cell tower identifier, a subscriber identifier, and a timestamp;
for each of said subscriber identifier, generating a set of mathematically descriptive location-derived statistics, said set of mathematically descriptive location-derived statistics being semantic-free and first order or greater statistics;
said telecommunications data further comprising call detail records, said call detail records comprising an originating subscriber identifier, a receiving subscriber identifier, and a timestamp;
for each of said originating subscriber identifier and said receiving subscriber identifier, generating a set of mathematically descriptive communications-derived statistics, said set of mathematically descriptive communications-derived statistics being semantic-free and first order or greater statistics; and
storing said mathematically descriptive location-derived statistics and said mathematically descriptive communications-derived statistics in a telecom database.

24. The system of claim 23, said method further comprising:
receiving a first query against said telecom database and generating a first subset of mathematically descriptive statistics; and
returning said first subset of said mathematically descriptive statistics in response to said query.

25. The system of claim 23, said mathematically descriptive location-derived statistics being at least one of a group composed of:
radius of gyration; and
movement entropy.

26. The system of claim 25, said mathematically descriptive communication-derived statistics being at least one of a group composed of:
relationship of call versus text; and
entropy of communication.

27. The system of claim 23, said at least one summary statistic being normalized over a plurality of said mobile devices.

28. The system of claim 23, said method further comprising:
receiving device usage data comprising app usage logs, said app usage logs comprising an app identifier, a usage measurement, and a timestamp, said app usage logs being associated with a subscriber identifier;
for each of said subscriber identifier, generating a list of mathematically descriptive device-usage-derived statistics, said set of mathematically derived device-usage-derived statistics being semantic-fee and first-order or greater statistics.

29. The system of claim 23, said device-usage-derived statistics comprising at least one of a group composed of:
count of distinct domains visited;
diversity of domains visited;
count of apps used;
diversity of apps used; and
app usage entropy.

30. The system of claim 29, said app usage entropy comprising app usage entropy for individual apps.

31. The system of claim 29, said app usage entropy comprising aggregated app usage entropy for a first set of apps.

32. The system of claim 31, said first set of apps being a subset of apps available on said mobile device.

33. The system of claim 31, said first set of apps being all apps available on said mobile device.
